(19) United States
(12) Patent Application Publication
(10) Pub. No.: US 2015/0222515 A1
(43) Pub. Date: Aug. 6, 2015

(54) MANAGEMENT AND ORCHESTRATION SERVER

(71) Applicant: HITACHI, LTD., Tokyo (JP)

(72) Inventors: Nodoka MIMURA, Tokyo (JP); Masashi YANO, Tokyo (JP); Michitaka OKUNO, Tokyo (JP); Yuta MUTO, Tokyo (JP); Daisuke ISHII, Tokyo (JP)

(21) Appl. No.: 14/578,520

(22) Filed: Dec. 22, 2014

(30) Foreign Application Priority Data
Feb. 6, 2014 (JP) 2014-020917

(51) Int. Cl. H04L 12/26; G06F 9/455

(52) U.S. Cl. CPC H04L 43/0876; G06F 9/45558; G06F 2009/45595

(57) ABSTRACT

A management and orchestration server which manages a plurality of types of virtualized nodes included in server group includes a scaling executing unit configured to command the server group to scale virtual machines included in each of the plurality of types of virtualized nodes, a traffic load measuring unit configured to manage a traffic load of each of the virtual machines, and a scaling amount determining unit configured to determine a number of the virtual machines to be scaled. In this case, the traffic load measuring unit acquires a traffic load for each of the traffic types to be processed by each of the plurality of types of virtualized nodes, and the scaling amount determining unit determines the type of virtualized node for which virtual machines are to be scaled and a number of machines to be scaled based on the traffic loads of the traffic types.

### CROSS-REFERENCE TO RELATED APPLICATION

This application claims the priority from Japanese Patent Application No. 2014-020917 filed on Feb. 6, 2014, which is incorporated herein by reference in its entirety.

### BACKGROUND OF THE INVENTION

1. Field of the Invention

The present invention relates to a management and orchestration server, and it particularly relates to a management and orchestration server which controls auto-scaling of network nodes in accordance with loads of virtualized network nodes in a communication system.

2. Description of the Related Art

NFV (Network Functions Virtualization) has been standardized in European Telecommunications Standards Institute (ETSI) mainly by communication carriers. NFV refers to a technology which virtualizes network nodes such as an EPC (Evolved Packet Core) in a mobile communication system, a firewall and a set top box, packages them into software, and executes them on virtual machines within general-purpose servers by incorporating cloud operation technologies and server virtualization technologies.

The major goals of NFV are to reduce introduction/operation costs and reduce a lead time for introducing a new service. Those network nodes listed above have been implemented by special hardware, and management and orchestration have been performed on each of network nodes. NFV, on the other hand, splits software and hardware for network nodes by virtualization and employs common general purpose hardware. In addition, migration to centralized management and orchestration has been attempted for achieving the goals. Hereinafter, a network node that is virtualized will be called a virtualized network node or simply called a virtualized node.

One of important technical problems for implementing NFV is auto-scaling which automatically increases or decreases the number of virtual machines included in a virtualized node in accordance with the throughput imposed on the virtualized node. A virtualized node includes a plurality of virtual machines having an identical network node functions though different users and flows are to be involved. Providing a plurality of virtual machines having a similar function may allow adjustment of a processing capability of a virtualized node. Scaling of virtual machines based on the throughput may power down an unnecessary apparatus in a general-purpose server group that operates them, which contributes to electric power saving. When a plurality of kinds of virtualized nodes is operated, use of common general-purpose servers in hardware may allow share and adjustment of resources of reserved hardware between virtualized nodes. Thus, the apparatuses may be used efficiently.

JP-A-2013-239913 discloses a method in a mobile communication system, including measuring a CPU utilization as a throughput for communication and processing to be performed by each virtual machine and, based on the value, determining the scaling amount of virtual machines included in the virtualized node, by a network manager which manages scaling of the virtualized node. JP-A-2012-208781 discloses a method in a Web server system including calculating a target size of a processing server (virtual machine) group in accordance with the data transfer rate to be transferred to the processing server group by a load balancer and the data transfer rate to be transferred to an alternative server for preparation for scaling-out of the processing server.

According to the method disclosed in JP-A-2013-239913, it is disadvantageously difficult to calculate an appropriate scale-out amount of virtual machines under a condition having an excessive load on a virtualized node, that is, in a condition that the CPU load of the virtual machine is 100%. This is because a maximum value of the throughput required by the virtualized node is not available. In such a condition, virtual machines are scaled-out one by one, which may take time to acquire a stable state with an appropriate number of virtual machines.

The method disclosed in JP-A-2012-208781 determines the number of processing servers to be scaled in consideration of a single type of transfer rate that passes through a load balancer and does not assume a plurality of kinds of traffic to be handled by the processing servers. Furthermore, disadvantageously, the method does not assume some types of traffic which have influence on a processing server having a certain function or some types of traffic which have additionally influence on a processing server having another function.

In particular, when NVF is applied to EPC in a mobile communication system, a plurality of types of virtualized node (such as P-GW, S-GW, and MME) must be handled, and a plurality of types of traffic (such as traffic for each message type of call control signaling or traffic for each packet length of a user data packet) must be handled. Furthermore, a virtualized node to be scaled may vary in accordance with the traffic type input to the system. Therefore, these problems are significant for implementing the method.

### SUMMARY OF THE INVENTION

Accordingly, the invention was made in view of these circumstances, and it is an object of the invention to solve at least a part of those problems.

Briefly summarizing the invention, there is disclosed a management and orchestration server which manages a plurality of types of virtualized nodes included in server group, the server including a scaling executing unit configured to instruct the server group to scale the number of virtual machines included in each of a plurality of types of virtualized nodes, a traffic load measuring unit configured to manage a traffic in each virtual machine, and a scaling amount determining unit configured to determine the number of virtual machines to be scaled, wherein the traffic load measuring unit acquires a traffic for each traffic type to be processed by a plurality of type of virtualized nodes, and the scaling amount determining unit determines the type of virtualized node for which the number of virtual machines is scaled and the number of virtual machine to be scaled based on the traffic of each traffic type.

According to the invention, auto-scaling of a plurality of types of virtualized nodes within a system may be addressed, and the convergence time for the auto-scaling may be reduced. The other problems, configurations and effects than those described above will be apparent from the following descriptions of embodiments.

### BRIEF DESCRIPTION OF THE DRAWINGS

FIG. 1 illustrates an example of a communication system;

FIG. 2 illustrates an example of a system configuration of a first embodiment;

FIG. 3 illustrates an example of a hardware configuration of one physical server included in a management and orchestration server and a physical server group;

FIG. 4 illustrates an example of a hardware configuration of a load balancer and a measuring node;

FIG. 5 illustrates an example of a processing sequence to which a definition of an input traffic type and a node definition are submitted from an administrator;

FIG. 6 illustrates an example of an input traffic type definition table;

FIG. 7 illustrates an example of a node definition table;

FIG. 8 illustrates an example of a virtual machine table;

FIG. 9 illustrates an example of a measurement queue table;

FIG. 10 illustrates an example of a processing sequence for adding virtual machine in a specific virtualized node;

FIG. 11 illustrates an example of a processing sequence for adding a virtual machine in a specific virtualized node;

FIG. 12 illustrates an example of a processing sequence for proposing to scale-out a physical server group to an administrator;

FIG. 13 illustrates an example of a regular traffic load transition table;

FIG. 14 illustrates an example of a flow chart for determining and executing an addition of a virtual machine to be included in a virtualized node;

FIG. 15 illustrates an example of a flow chart for determining and proposing a scaling-out time for a physical server group;

FIG. 16 illustrates a system configuration example according to second embodiment; and

FIG. 17 illustrates a system configuration example according to third embodiment.

### DESCRIPTION OF THE PREFERRED EMBODIMENTS

Embodiments will be described below by dividing them into a plurality of sections or embodiments as necessity arises for convenience. These sections and embodiments are related with each other unless otherwise specified, and there is a relationship that one may be a variation, a detail, an example for supplementary description or the like of a part or all of the other. Those embodiments may be implemented either separately or in combination.

Numbers (including the number, a numerical value, an amount, and a range) of elements, for example, referred in the following embodiments are not limited to the specific numbers and may be equal to or higher or lower than the numbers unless otherwise specified or unless they are apparently limited to specific numbers in principle.

Moreover, it should be understood that components (including elements and steps) of the following embodiments are not always required unless otherwise specified and unless they may be apparently considered as required in principle.

Also the forms, positional relationships and so on of components referred in the following embodiments include those essentially approximate or similar to the form and so on unless otherwise specified and unless they may not be considered in principle. This is true for the numerical values and ranges.

### First Embodiment

According to a first embodiment, a management and orchestration server in a packet communication system will be described in order of its system and processing (sequences and flows).

### System

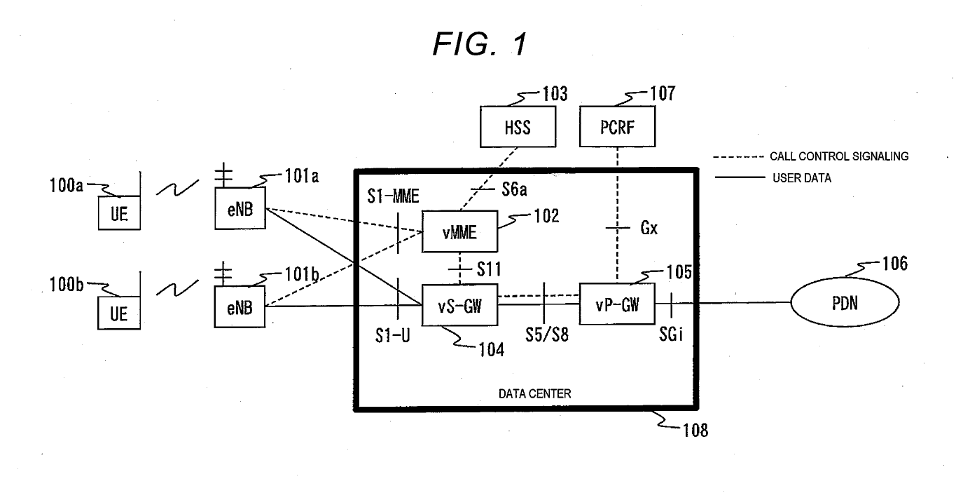

First, an example of a configuration of a communication system of this embodiment will be described with reference to FIG. 1. In this case, an EPC of a mobile communication system based on 3GPP LTE is configured by virtualized nodes, as an example of the communication system. A user terminal UE (User Equipment) (100a, 100b) communicates with a radio base station eNB (Evolved Node B) (101a, 101b) which mutually converts a radio signal to a wired signal through a radio interface. The eNB (101a, 101b) communicates call control signaling with a mobility management gateway vMME (Virtualized Mobility Management Entity) 102 that is a virtualized node. The vMME 102 is an apparatus configured to manage a radio connection state of a UE of each user and sets a path for a user data traffic to/from another EPC apparatus. The vMME 102 further communicates call control signaling with a subscriber management server HSS (Home Subscriber Server) 103. The HSS 103 is an apparatus configured to manage authentication information and service information of the UE (100a, 100b). The eNB (101a, 101b) further communicates a user data packet with a radio access network gateway vS-GW (Virtulized Serving Gateway) 104 that is a virtualized node. The vS-GW 104 is an apparatus configured to transfer user data traffic to a proper eNB to which the UE belongs. The vS-GW 104 communicates call control signaling and a user data packet with a packet data network gateway vP-GW (Virtulized Packet Data Network Gateway) 105 that is a virtualized node. The vP-GW 105 is an apparatus configured to transfer a user data packet to a proper PDN (Packet Data Network) 106. The PDN 106 may be the Internet or an enterprise network having a terminal which achieves end-to-end communication with an UE (100-1,100-2) through the mobile communication system. The vP-GW 105 communicates call control signaling with a policy management server PCRF (Policy and Charging Rules Function) 107. The PCRF 107 is an apparatus configured to set communication quality produced by the vP-GW 105 for each user.

FIG. 1 illustrates one vMME 102, one vS-GW 104, and one vP-GW 105, but a plurality of them may exist in accordance with the size of the communication system. The vMME 102, vS-GW 104, and vP-GW 105 are virtualized nodes, as described above, and are generally placed within a data center 108 having a generic physical server group.

Reference point names are given to interfaces between apparatuses. An interface between the eNB (101a, 101b) and the vMME 102 will be called “S1-MME”. An interface between the vMME 102 and the MSS 103 will be called “S6a” . An interface between the eNB (101a, 101b) and the vS-GW 104 will be called “S1-U”. An interface between the vS-GW 104 and the vMME 102 will be called “S11”. An interface between the vS-GW 104 and the vP-GW 105 will be called “S5/S8”. An interface between the vP-GW 105 and the PCRF 107 will be called “Gx”. An interface between the vP-GW 105 and the PDN 107 will be called “SG1”. In the mobile communication system, the protocol to be applied may differ in accordance with the reference point.

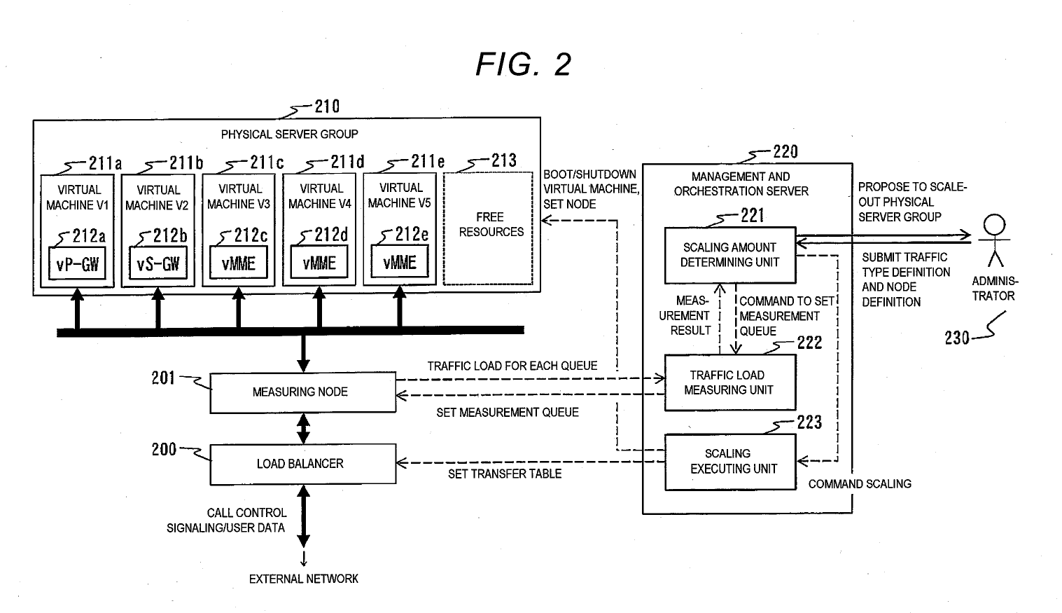

Next, an example of a system configuration of this embodiment will be described with reference to FIG. 2. The system configuration corresponds to a configuration within the data center 108 illustrated in FIG. 1. This system includes a physical server group 210, a load balancer 200, a measuring node 201, and a management and orchestration server 220. These apparatuses are connected via a switch or a router. The physical server group 210 includes virtual machines configuring virtualized nodes. In FIG. 2, virtual machines V1 to V5 (211a to 211e) are in operation, and they are executing virtualized node software vP-GW 212a, vS-GW 212b, and vMME (212c to 212e). The physical server group 210 includes a predetermined amount of free resources (such as a CPU resource and a memory resource) 213 which is usable for booting a virtual machine. The load balancer 200 is capable of allotting call control signaling or a user data packet received from an external network to a proper virtual machine. For example, referring to FIG. 2, the virtual machines V3 to V5 (211c to 211e) configure vMME as one virtualized node. The load balancer 200 identifies a target user of a call control signaling packet and then transfers the packet to a virtual machine holding the corresponding user information. The measuring node 201 is an apparatus located between the load balancer 200 and the virtual machines V1 to V5 (211a to 211e) for identifying the type of traffic (traffic type) flowing therebetween and measuring statistics information on the traffic type. Concrete examples of the traffic type will be described in the section Processing (Sequence) below.

The management and orchestration server 220 is an apparatus configured to control virtual machine scaling of each virtualized node in accordance with the traffic load of the corresponding traffic type. The management and orchestration server 220 includes a scaling amount determining unit 221, a traffic load measuring unit 222, and a scaling executing unit 223. The scaling amount determining unit 221 has an interface through which an administrator 230 submits a definition of a traffic type to be input to a virtualized node (input traffic type definition) and a node definition of the virtualized node (virtualized node definition). Concrete examples of the input traffic type definitions and virtualized node definitions will be described in the section Processing (Sequence) below. The scaling amount determining unit 221 issues a measurement queue setting command for the traffic type to be measured by the measuring node 201 to the traffic load measuring unit 222 and acquires a measurement result therefrom. The scaling amount determining unit 221 further determines the scaling amount of virtual machines for a virtualized node based on the measurement result and issues a scaling command to the scaling executing unit 223. The traffic load measuring unit 222 sets a measurement queue for a traffic type to be measured for the measuring node 201 and acquires the traffic load for each queue from the measuring node 201. The scaling executing unit 223 receives a scaling execution command from the scaling amount determining unit 221 and boots or shuts down a virtual machine and sets a virtualized node for the physical server group 210. The scaling executing unit 223 resets the transfer table in the load balancer 200 in accordance with the scaling.

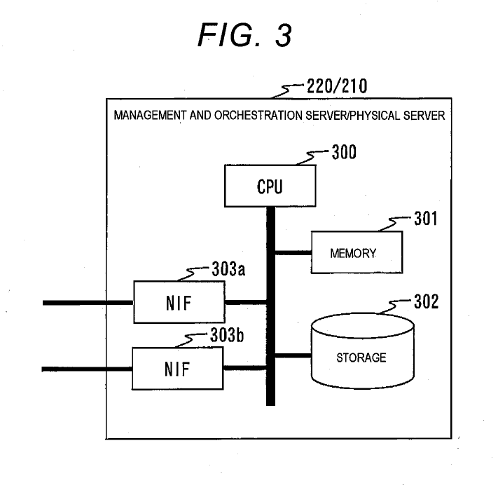

FIG. 3 illustrates an example of a hardware configuration of one physical server included in the management and orchestration server 220 and physical server group (210) according to this embodiment. The management and orchestration server 220 includes a CPU 300, a memory 301, a storage 302, and NIFs (Network Interface) 303. Software programs for providing functions of the scaling amount determining unit 221, traffic load measuring unit 222, and scaling executing unit 223 are stored in the storage 302 and are decompressed in the memory 301 when the apparatus is booted. The CPU 300 sequentially reads and executes the software programs decompressed in the memory 301. The NIFs 303a and 303b are a management network interface for communication with another apparatus within a system and a network interface for data for transmission/reception of call control signaling and user data packet based on mobile communication.

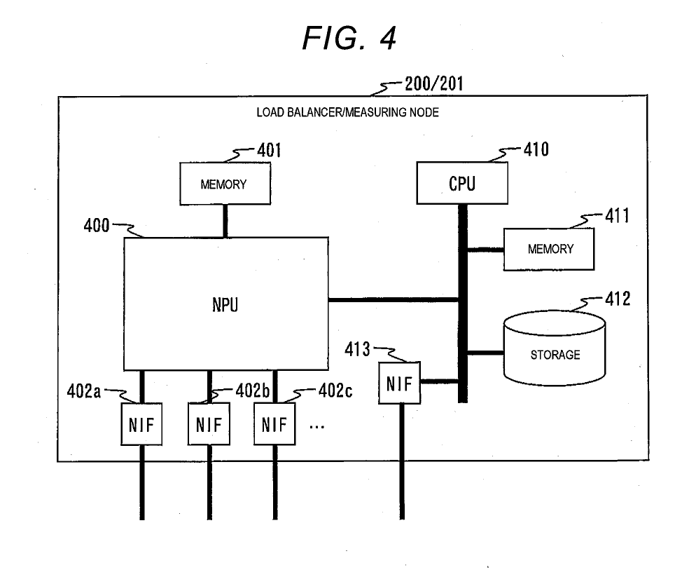

FIG. 4 illustrates an example of a hardware configuration of the load balancer 200 or measuring node 201 according to this embodiment. This embodiment assumes that the load balancer 200 and measuring node 201 have a similar hardware configuration and that their functions depend on software programs stored therein. The load balancer 200 and measuring node 201 include a region (including an NPU (Network Processing Unit) 400, a memory 401, and NIFs (402a to 402c)) for processing call control signaling and a user data packet transmitted/received to/from an external network and a region (including the CPU 410, memory 411, storage 412, and NIF 413) for setting and controlling the apparatus. The NIFs (402a to 402c) connect to an external network and transmits/receives call control signaling and a user data packet. A software program which provides a load balancer function or a measurement function is downloaded to the NPU 400 and performs processing on a transmitted or received call control signaling or user data packet. A transfer table required for the load balancer function and a measurement queue table required for a measurement function are decompressed on the memory 401. On the other hand, a software program for providing a function for setting the apparatus is stored in the storage 412 and is decompressed in the memory 411 upon startup of the apparatus. The CPU 410 sequentially reads and executes a software program decompressed within the memory 411. The NIF 413 is a management network interface for communication with the management and orchestration server. The CPU 410 reads a software program which provides a load balancer function or a measurement function from the memory 411 and downloads it to the NPU 400. The CPU 410 further decompresses the transfer table or measurement queue table in the memory 401 in response to a command from the management and orchestration server 220. The system of this embodiment has been described above.

### Processing (Sequence)

Four processing routines according to this embodiment will be described in processing in which a management and orchestration server configured to manage scaling of a plurality of types of virtualized nodes measures a traffic load for each input traffic type processed by the virtualized nodes and determines the type of virtualized node for which the virtual machines are scaled and the scaling amount based on the traffic load of each input traffic type. More specifically, the four processing routines are (A) processing routine to which an administrator submits settings for an input traffic type definition and a node definition, (B) processing routine for scaling-out virtual machines of a specific virtualized node, (C) processing routine for scaling-in virtual machines of a specific virtualized node, and (D) processing routine for proposing to scale-out a physical server group to the administrator.

(A) Processing Routine to Which Input Traffic Type Definition and Node Definition are Submitted from Administrator

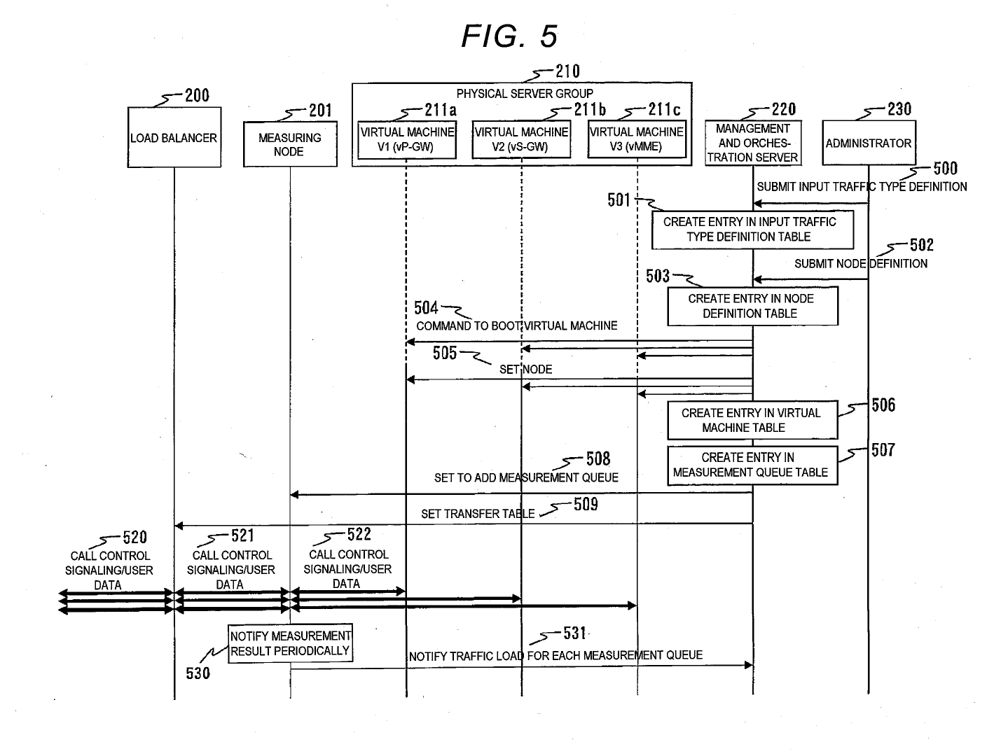

A routine for setting a system by the management and orchestration server in response to an input traffic type definition and a node definition submitted from an administrator will be described with reference to FIG. 5. First, the administrator 230 submits a definition of an input traffic type to be set as a measurement target to the management and orchestration server 220 (step 500). The management and orchestration server 220 creates an entry in an input traffic type definition table, which will be described below, and the input definition information is set in the table (step 501).

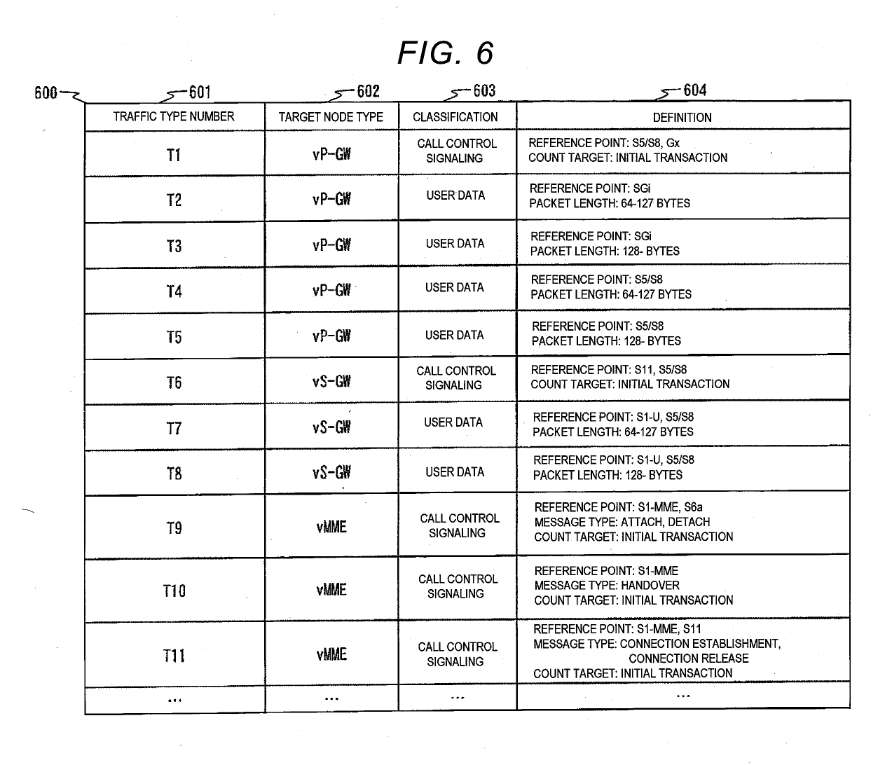

FIG. 6 illustrates an example of a data configuration of the input traffic type definition table. An input traffic type definition table 600 includes items of a traffic type number 601, a target node type 602, a classification 603, and a definition 604. The traffic type number 601 indicates an identification number of an entry. The target node type 602 indicates a type of a virtualized node to which traffic of the traffic type is input. The classification 603 indicates whether the traffic type is call control signaling or a user data packet. The definition 604 indicates a specific definition of the traffic type. Entries T1 to T5 are definitions of traffic types relating to vP-GW.

The entry T1 defines to measure an initial transaction packet (message packet which is a starting point among a series of call control sequences relating to mobile communication) among call control signaling packets input from the reference points “S5/S8” and “Gx” illustrated in FIG. 1. The entries T2 to T5 define to measure user data packets by categorizing them based on the reference points “SGi” and “S5/S8” illustrated in FIG. 1 or based on a packet length of 128 bytes or larger and a smaller packet length respectively. This is because the packet transfer throughput may differ according to the reference point or because the overhead of packet transfer may differ according to the packet length.

On the other hand, the entries T6 to T8 define traffic types relating to vS-GW. The entry T6 defines to measure an initial transaction packet of call control signaling packets input from the reference points “S11” and “S5/S8” illustrated in FIG. 1. The entries T7 and T8 define to measure user data packets by categorizing them based on a packet length of 128 bytes or larger and a smaller packet length for the reference points “S1-U” and “S5/S8” illustrated in FIG. 1. These definitions are based on an assumption that the transfer throughputs at the reference points “S1-U” and “S5/S8” for user data packets are equal and the traffic types are therefore the same.

The entries T9 to T11 are traffic type definitions relating to vMME. The entries T9 to T11 define to measure initial transaction packets of attach/detach, handover, and connection establish/connection release (reservation/release of radio resources for communication), respectively, which are message types of call connection signals. This is because the throughput of a series of call control sequences may differ from message type to message type of call control signalings. Thus, the traffic types to be measured may be defined individually.

Referring back to FIG. 5, the administrator 230 submits a node definition for a virtualized node to be moved within the system to the management and orchestration server 220 (step 502). The management and orchestration server 220 creates an entry in a node definition table, which will be described below, and the submitted definition information is set in the table (step 503).

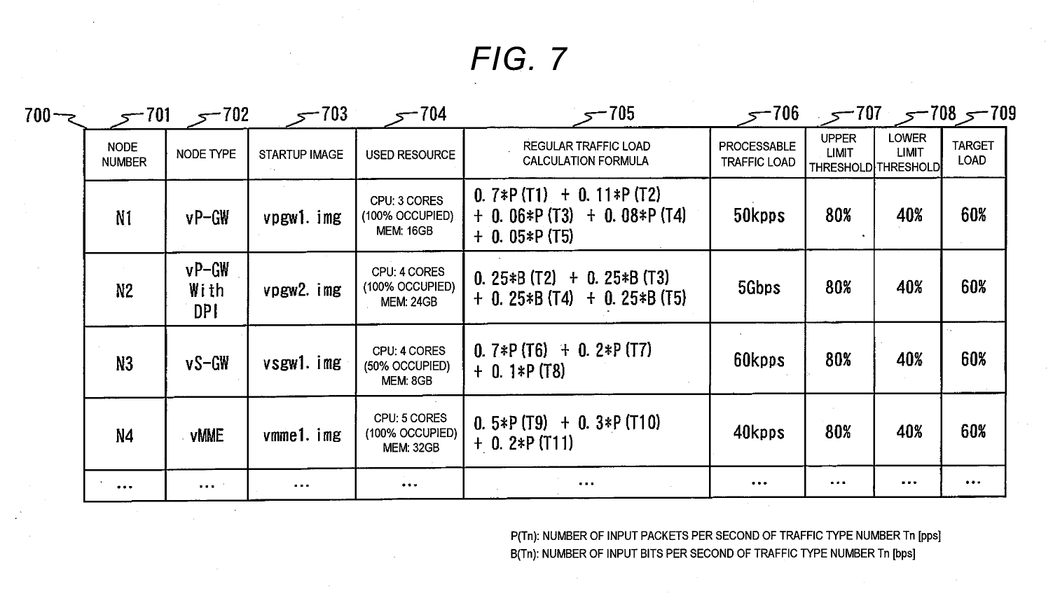

FIG. 7 illustrates an example of a data configuration of the node definition table. A node definition table 700 includes a node number 701, a node type 702, a startup image 703, a used resource 704, a regular traffic load calculation formula 705, a processable traffic load 706, an upper limit threshold 707, a lower limit threshold 708, and a target load 709. The node number 701 indicates an identification number of an entry. The node type 702 indicates a type of a virtualized node. The startup image 703 indicates a filename of a virtual machine image for operation as the virtualized node. The used resource 704 indicates an amount of physical resource required for booting one virtual machine included in the virtualized node. The regular traffic load calculation formula 705 indicates a calculation formula for evaluating a present traffic load imposed on one virtual machine. How it is calculated will be described below. The processable traffic load 706 indicates a maximum traffic load processable by one virtual machine. An upper limit threshold 707 indicates a load threshold condition for determining execution of scaling-out of virtual machines. The lower limit threshold 708 indicates a load threshold condition for determining execution of scaling-in of virtual machines. The target load 709 indicates a desired value of an average load desired to be loaded on each of virtual machines after the virtual machines are scaled.

The regular traffic load calculation formula 705 will be described. In virtualized nodes such as an EPC, one virtualized node handles many input traffic types, different loads of the traffic processing are imposed thereon. Therefore, in order to evaluate an accurate traffic load imposed on each virtual machine, normalization may be required which integrates proportions of throughputs to traffic loads of those traffic types. The regular traffic load calculation formula 705 indicates a calculation formula for the normalization. More specifically, it is calculated by using the following mathematical expressions (1) and (2):

$$\begin{matrix}Regular traffic load = \sum Ai \times R ( Ti ) & ( 1 ) \\ Ai = \frac{1 / R max ( Ti )}{{\sum }_{j}^{ } 1 / R max ( Tj )} & ( 2 )\end{matrix}$$

Here, R(Tn) is a traffic load measured for a traffic type number Tn. Rmax(Tn) is a maximum traffic load measured when traffic for the traffic type number Tn is only input to the virtual machine. Ai is a coefficient. A reciprocal of Rmax(Tn) is converted to a throughput for the traffic type to calculate its proportion to the whole throughput. Because a virtualized node does not require special hardware, it is easy to evaluate a maximum traffic in advance as described above before the operation of the node actually starts.

Entries N1 and N2 will be described as entry examples of the node definition table 700. The entry N1 has a node definition of vP-GW for the node type 702. The virtual machine is booted based on vpgw 1.img for the startup image (703). Three cores of CPU resources may be required for the used resource 704 and are occupied 100%. Memory resources including up to 16 GB may be required. For the regular traffic load calculation formula 705, the traffic loads of the traffic type numbers T1 to T5 defined in the input traffic type definition table 600 in FIG. 6 are used. The calculation formula is defined by using the mathematical expressions (1) and (2). Here, P(Tn) represents the number of input packets per second measured from the traffic type number Tn. The processable traffic load 705 of one virtual machine is equal to 50 kpps (Packets Per Second). The upper limit load 706, lower limit load 707, and target load 708 are 80%, 40%, and 60%, respectively.

On the other hand, under the entry N2, vP-GW which only having a DPI (Deep Packet Inspection) function which only processes a user data traffic is defined for the node type 702. The DPI function is a function useful for quality control by examining and identifying a packet payload of a user data packet. For the regular traffic load calculation formula 705, the traffic loads of the traffic type numbers T2 to T5 defined in the input traffic type definition table 600 in FIG. 6 are used. The calculation formula is defined by using the mathematical expressions (1) and (2). Here, B(Tn) represents the number of input bits per second measured for the traffic type number Tn. If the DPI function is provided, the throughput depends on the number of bits per second (the number of bytes per second) instead of the number of packets per second. Therefore, B(Tn) is used here. The processable traffic load 705 of one virtual machine is 5 Gbps (Bits Per Second).

As represented by the regular traffic load calculation formula 705 in FIG. 7, for example, vP-GW or vS-GW may allow a higher throughput for one packet generally with call control signaling traffic than user data traffic. Therefore, a normalized traffic load is calculated by applying a larger weight to call control signaling traffic than user data traffic. For example, vMME allows a higher throughput for one packet generally with call control signaling traffic for attachment or detachment than call control signaling traffic for handover or connection establishment or connection release. Therefore, a normalized traffic load is calculated by applying a larger weight to call control signaling traffic for attach or detach than call control signaling traffic for handover, connect establishment or connection release.

As described above, the input traffic type for which a traffic load is to be measured is defined, and a regular traffic load which is calculated from a traffic load for each virtualized node is defined. This allows auto-scaling of a plurality of types of virtualized nodes within a system. Furthermore, the traffic load measurement may be used for determining the proper number of machines to be scaled. Thus, the convergence time of the auto-scaling may be reduced.

Referring back to FIG. 5, the management and orchestration server 230 allocates physical resources and issues a boot command for virtual machines to the physical server group 210 in order to configure a virtualized node in accordance with the submitted node definition (step 504). In this case, the virtual machine V1 (vP-GW) 211a, virtual machine V2 (vS-GW) 211b, and virtual machine V3 (vMME) 211c are booted one by one. After that, system parameters for operation as a virtualized node are set for the booted virtual machines (211a to 211c) (step 505). The management and orchestration apparatus 220 creates entries in a virtual machine table, which will be described below, and stores information regarding the booted virtual machines (step 506).

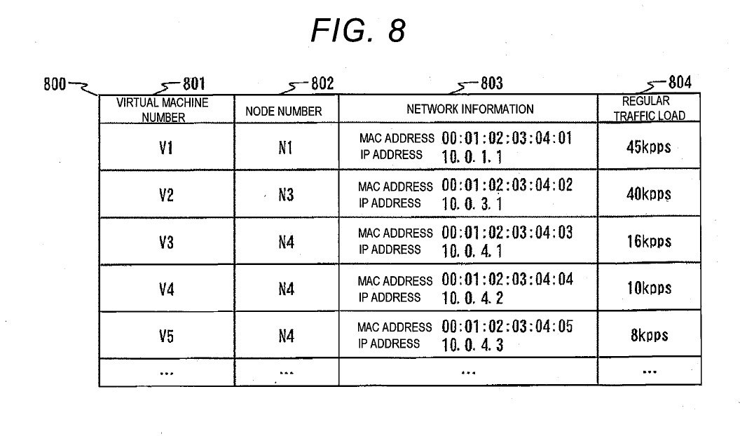

FIG. 8 illustrates an example of a data structure of the virtual machine table. A virtual machine table 800 includes items of a virtual machine number 801, a node number 802, a network information (803), and a regular traffic load 804. The virtual machine number 801 indicates an identification number of an entry. The node number 802 indicates which virtualized node the virtual machine is and corresponds to the node number 701 in the node definition table 700 in FIG. 7. The network information 803 stores information on a MAC (Media Access Control) address and an IP (Internet Protocol) address assigned to the virtual machine. The regular traffic load 804 indicates a current traffic load calculated from the regular traffic load calculation formula 705 in the node definition table 700. FIG. 8 illustrates that entries are created by defining the virtual machine number V1 as vP-GW of the node number N1, the virtual machine number V2 as vS-GW of the node number N3 and the virtual machine number V3 to V5 as vMME of the node number N4.

Referring back to FIG. 5, the management and orchestration server 220 creates entries in a measurement queue table, which will be described below, based on the submitted input traffic type definition and node definition (step 507).

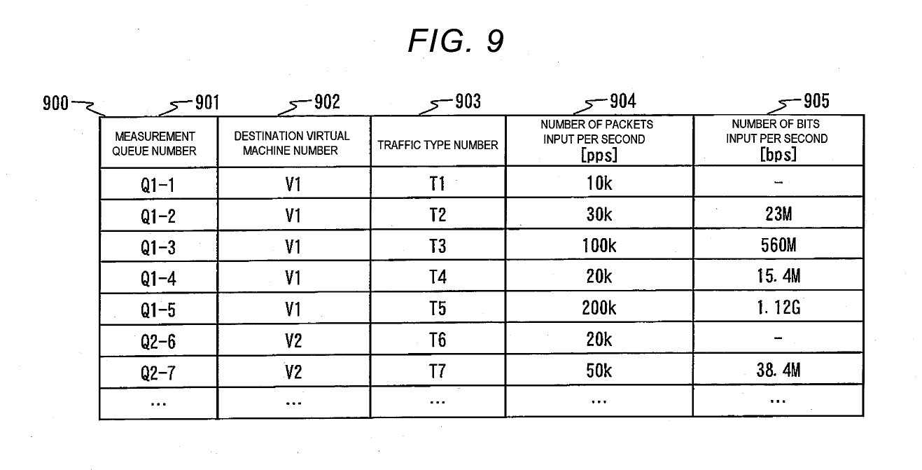

FIG. 9 illustrates an example of a data configuration of a measurement queue table. A measurement queue table 900 includes items of a measurement queue number 901, a destination virtual machine number 902, a traffic type number 903, a number of packets input per second 904, and a number of bits input per second 905. The measurement queue number 901 indicates an identification number of an entry. The destination virtual machine number 902 indicates a destination virtual machine of the traffic and corresponds to the virtual machine number 801 in the virtual machine table 800 in FIG. 8. A MAC address and an IP address which are included in the network information 803 may be retrieved from the virtual machine table 800. The traffic identification number 903 indicates an input traffic type and corresponds to the traffic type number 601 in the input traffic type definition table 600 in FIG. 6. The number of packets input per second 904 and number of bits input per second 905 store measurement results acquired from the measuring node 201, which will be described below. In FIG. 9, the entries Q1-1 to Q1-5 are set measurement queues for the virtual machine number V1 and are measurement queues for measurement for the traffic identification numbers T1 to T5, respectively. They include the traffic type numbers included in the regular traffic load calculation formulas 705 in the node definition table 700 in FIG. 7.

Referring back to FIG. 5, the management and orchestration server 220 sets to add a measurement queue for the measuring node 201 based on the entry information in the measurement queue table 900 created in step 507 (step 508). For this setting, information on the measurement queue number 901, the network information 803 in the virtual machine table 800 corresponding to the destination virtual machine number 902, and the definition 604 in the input traffic type definition table 600 corresponding to the traffic type number 903 are included among the entry information in the measurement queue table 900. After that, the management and orchestration server 220 sets a transfer table for the load balancer 200 such that a packet destined to a virtualized node received from an external network may be transferred to a proper virtual machine (step 509).

Upon completion of these setting operations, call control signaling packets and user data packets are transferred from an external network to the load balancer 200, measuring node 201, and virtual machines V1 to V3 (211a to 211c) (step 520 to 522). The measuring node 201 measures traffic loads of the number of input packets and number of input bits for the measurement queues and periodically notifies a traffic load for each measurement queue to the management and orchestration server 220 (step 530 to 531). The management and orchestration server 220 in response to the notification stores the traffic loads in the number of packets input per second 904 and number of bits input per second 905 in the measurement queue table 900 in FIG. 9.

The routine for system setting to be performed by a management and orchestration server based on an input traffic type definition and a node definition has been described above. By following the routine, the input traffic type definition and the node definition may be flexibly changed. It may facilitate to follow an update of an existing service, introduction of a new service, a change of a logical configuration for each service, which contributes to automation and operation cost reduction of management and orchestration which is an object of the NFV.

### (B) Processing Routine for Scaling-Out Virtual Machines in Specific Node

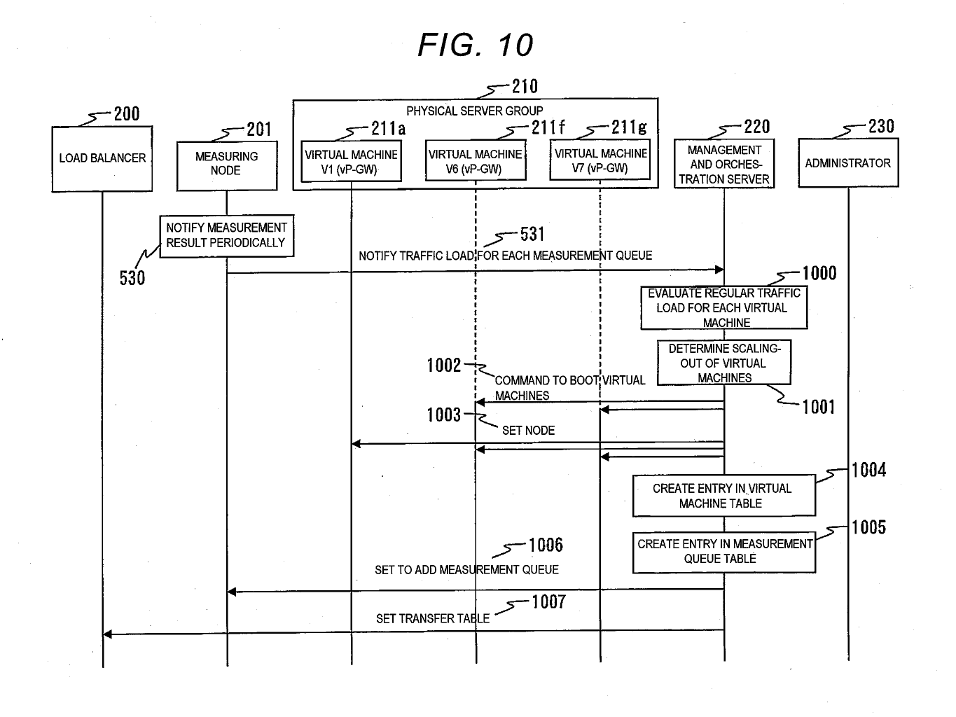

With reference to FIG. 10, a routine will be described in which a management and orchestration server determines scaling-out of virtual machines in a specific virtualized node and executes scaling-out of virtual machines. Here, it is assumed that vP-GW is a target virtualized node. It is further assumed that the virtual machine V1 (211a) has already been booted and that new virtual machines V6 and V7 (211f, 211g) are to be scaled out.

The measuring node 201 measures traffic loads of the number of input packets and number of input bits for a set measurement queue and periodically notifies a traffic load for each measurement queue to the management and orchestration server 220 (similarly to steps 530 to 531). The management and orchestration server 220 in response to the notification stores the traffic loads in the number of packets input per second 904 and number of bits input per second 905 in the measurement queue table 900 in FIG. 9.

Next, the management and orchestration server 220 evaluates a regular traffic load for each virtual machine based on the measured traffic loads of each measurement queue and records it in the regular traffic load 804 of the virtual machine table 800 (step 1000). The regular traffic load to be recorded here may be an instantaneous value based on an immediately preceding measured traffic load or may be a simple moving average value or index moving average value calculated in consideration of past values. Then, the management and orchestration server 220 calculates a throughput imposed on each of the virtual machines from the evaluated regular traffic load and the processable traffic load 706 set in the node definition table 700. If the throughput is higher than the upper limit threshold set in the node definition table 700, execution of scaling-out of the virtualized node to which the virtual machine belongs, that is, scaling-out of the virtual machines is determined (step 1001). A specific flow of the determination will be described in the section Processing (flowchart). The management and orchestration server 220 calculates the number N of virtual machines that are currently required by using the following mathematical expression (3).

Required Number of Virtual Machines N=(RoundUp(Total of Present Regular Traffic Load/processable Traffic Load of one Virtual Machine×Target Load) (3)

Then, the number of virtual machines to be scaled out is determined from the difference from the current number of virtual machines.

Here, the RoundUp function is a function for rounding up after the decimal point. The numerator is a total of regular traffic loads of all virtual machines included in the virtualized node to be scaled out. The denominator is a product of the processable traffic load 706 and the target load 709 for one virtual machine included in the node definition table 700.

By following this routine, the proper number of scale-out target virtual machines may be determined from a traffic load measurement result, which may reduce the convergence time of auto-scaling.

Referring back to FIG. 10, the management and orchestration server 220 allocates physical resources to the physical server group 210 for the determined number of scale-out target machines and issues a command to boot virtual machines (step 1002). In this case, two of the virtual machine V6 (vP-GW) 211f and virtual machine V7 (vP-GW) 211g are booted. The management and orchestration server 220 sets, for the booted virtual machines V6 and V7 (211f, 211g), a system parameter for operating as a virtualized node. At the same time, the management and orchestration server 220 may set migration of user information held between virtual machines, for example, with the scale out of the virtualized node (step 1003). The management and orchestration server 220 additionally creates entries in the virtual machine table 800 in FIG. 8 and stores information on the newly booted virtual machines V6 and V7 (211f, 211g) (step 1004).

The management and orchestration server 220 additionally creates entries of measurement queues for the newly booted virtual machines V6 and V7 (211f, 211g) in the measurement queue table 900 in FIG. 9 based on the submitted input traffic type definition and node definition (step 1005). The management and orchestration server 220 sets to add the measurement queues for the measuring node 201 based on the additionally created entry information in the measurement queue table 900 (step 1006). For the setting, the network information 803 in the virtual machine table 800 corresponding to the measurement queue number 901 and destination virtual machine number 902 and information on the definition 604 in the input traffic type definition table 600 corresponding to the traffic type number 903 are included among the entry information in the measurement queue table 900. After that, the management and orchestration server 220 resets the transfer table for the load balancer 200 such that a packet received from an external network and destined to the virtualized node may be transferred to the proper virtual machine (step 1007).

The routine has been described above in which a management and orchestration server determines to scale-out virtual machines in a specific virtualized node and executes the scale-out of the virtual machines. Following the routine allows auto scale-out of a plurality of types of virtualized node within a system and determination of a proper number of scale-out target virtual machines based on measurement results of traffic loads by one operation, reducing the convergence time of the auto scale-out. The proper allocation of free resources to virtual machines to be scaled out in a scale-out target virtualized node allows highly efficient operations to be performed by a plurality of virtualized nodes sharing standby equipment.

### (C) Processing Routine For Scaling-In Virtual Machines in Specific Node

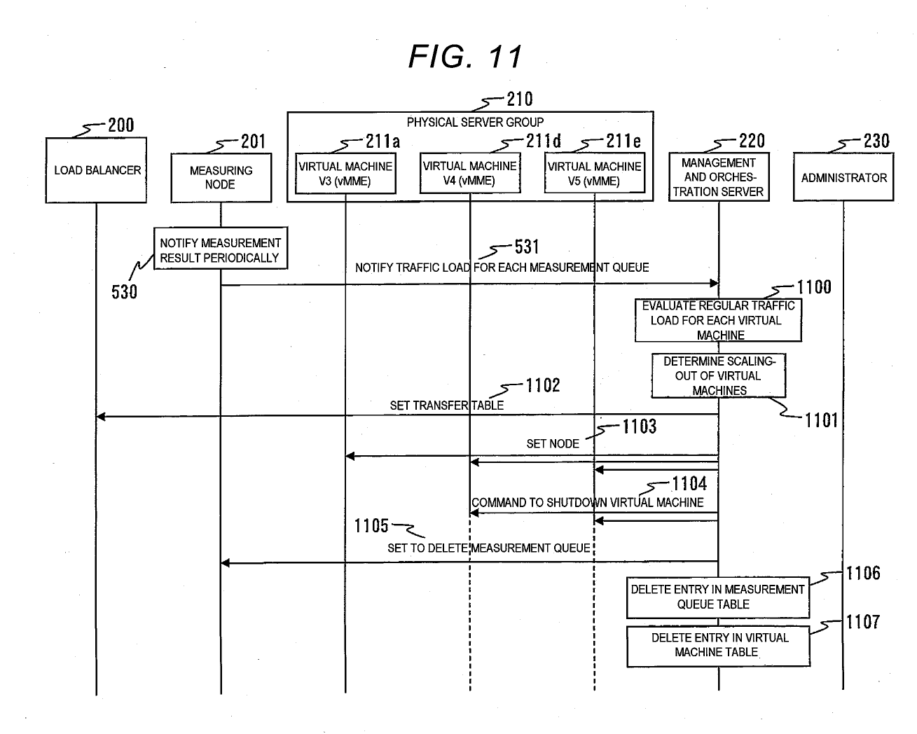

With reference to FIG. 11, a routine will be described in which a management and orchestration server determines scale-in of virtual machines in a specific virtualized node and executes scale-in of virtual machines. In this case, it is assumed that the target virtualized node is vMME. It is further assumed that the virtual machines V3 to V5 (211c to 211e) already have a booted status and the virtual machines V4 and V5 (211d, 211e) are to be scaled in.

The measuring node 201 measures traffic loads of the number of input packets and the number of input bits for set measurement queues and periodically notifies the management and orchestration server 220 of the traffic load for each of the measurement queues (similarly to steps 530 to 531). The management and orchestration server 220 in response to the notification stores the traffic loads in the number of packets input per second 904 and the number of bits input per second 905 in the measurement queue table 900 in FIG. 9.

Next, the management and orchestration server 220 evaluates a regular traffic load for each of the virtual machines based on the measured traffic loads of the corresponding measurement queue and records it in the regular traffic load 804 in the virtual machine table 800 (step 1100). In this case, the regular traffic load to be recorded may be an instantaneous value based on the immediately preceding measured traffic load or may be a simple moving average value or index moving average value calculated in consideration of past values. The management and orchestration server 220 calculates a throughput imposed on each of the virtual machines from the evaluated regular traffic load and the processable traffic load 706 set in the node definition table 700. If the throughput is lower than the lower limit threshold set in the node definition table 700, execution of scaling-in of the virtualized node to which the virtual machine belongs, that is, scaling-in of the virtual machines is determined (step 1101). A specific flow of the determination will be described in the section Processing (flowchart). The management and orchestration server 220 calculates the number N of virtual machines that are currently required by using the mathematical the mathematical expression (3) above. Then, the number of virtual machines to be scaled in is determined from the difference from the current number of machines.

By following this routine, the proper number of scale-in target machines may be determined from a traffic load measurement result by one operation, which may reduce the convergence time of auto-scaling.

Referring back to FIG. 11, the management and orchestration server 220 resets the transfer table for the load balancer 200 such that a packet received from an external network and destined to the virtualized node may not be transferred to the scale-in target virtual machines after this (step 1102). It is assumed that two of the virtual machine V4 (vMME) 211d and virtual machine V5 (vMME) 211e are to be shut down. The management and orchestration server 220 may set migration of user information held between the virtual machines, for example, with the scale in of the virtualized node (step 1103). After that, the management and orchestration server 220 issues a virtual machine shutdown command for the determined number of scale-in target virtual machines to the physical server group 210 and releases the allocated physical resources (step 1104).

The management and orchestration server 220 sets to delete measurement queues relating to the scaled-in virtual machines V4 and V5 (211d, 211e) for the measuring node 201 based on the entry information in the measurement queue table 900 in FIG. 9 (step 1105). For the setting, the measurement queue number 901 is included among the entry information in the measurement queue table 900. Then, the management and orchestration server 220 deletes the entries of the measurement queues relating to the scaled-in virtual machines V4 and V5 (211d, 211e) from the measurement queue table 900 (step 1106). After that, the management and orchestration server 220 deletes entries of the virtual machines V4 and V5 (211d, 211e) from the entries in the virtual machine table 800 in FIG. 8 (step 1107).

The routine has been described in which a management and orchestration server determines to scale in virtual machines in a specific virtualized node and executes the scale-in of the virtual machines. Following the routine allows auto scale-in of a plurality of type virtualized nodes within a system and determination of a proper number of scale-in target virtual machines based on measurement results of traffic loads by one operation, reducing the convergence time of the auto scale-in. The proper allocation of free resources acquired by the scale-in of the virtual machines to virtual machines to be scaled out in a scale-out target virtualized node allows highly efficient operations to be performed by a plurality of virtualized nodes sharing standby equipment.

### (D) Processing Routine for Proposing to Scale Out Physical Server Group to Administrator

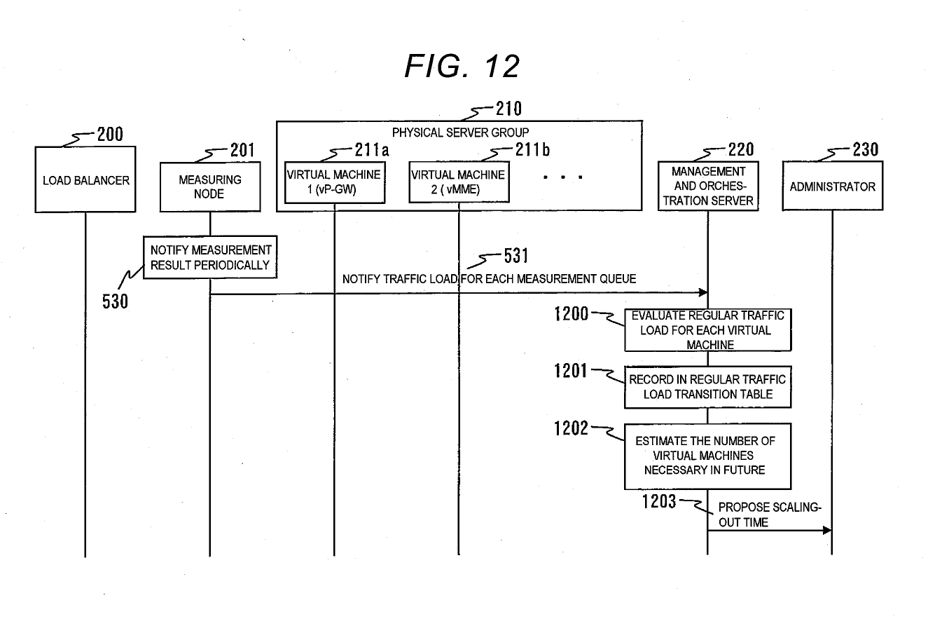

With reference to FIG. 12, a routine will be described in which a management and orchestration server forecasts shortage of free resources for a physical server group and proposes to scale out the physical server group to an administrator.

The measuring node 201 measures traffic loads of the number of input packets and the number of input bits for set measurement queues and periodically notifies the management and orchestration server 220 of the traffic load of each measurement queue (similarly to steps 530 to 531). The management and orchestration server 220 in response to the notification stores the traffic loads in the number of packets input per second 904 and the number of bits input per second 905 in the measurement queue table 900 in FIG. 9. Next, the management and orchestration server 220 evaluates a regular traffic load for each of the virtual machines based on the measured traffic loads of the corresponding measurement queue and records it in the regular traffic load 804 in the virtual machine table 800 (step 1200). In this case, the regular traffic load to be recorded may be an instantaneous value based on the immediately preceding measured traffic load or may be a simple moving average value or index moving average value calculated in consideration of past values. After that, the management and orchestration server 220 also records the recorded value of the regular traffic load in a regular traffic load transition table, which will be described below (step 1201).

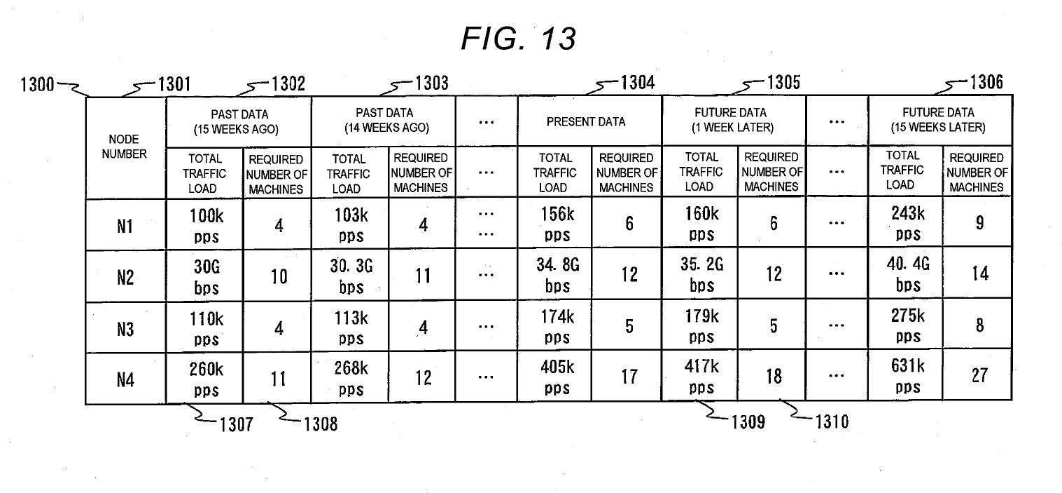

FIG. 13 illustrates an example of a data configuration in a regular traffic load transition table. A regular traffic load transition table 1300 includes items of a node number 1301, past data (1302, 1303), present data 1304, and future data (1305, 1306). The past data is subdivided into predetermined periods such as past data (15 weeks ago) 1302 and past data (14 weeks ago) 1303. The future data is subdivided into predetermined periods such as future data (1 week later) 1305 and future data (15 weeks later) 1306. Each item of the data further includes sub-items of a total of traffic loads (1307, 1309) and a required number of machines (1308, 1310). The node number 1301 indicates an identification number of an entry created for each virtualized node and is similar to the node number 701 in the node definition table 700 in FIG. 7. The past data (15 weeks ago) 1302 indicates the total of traffic loads 1307 and the required number of machines 1308 recorded 15 weeks ago from the present time. The total of traffic loads 1307 indicates a total of values of regular traffic loads of all virtual machines included in the virtualized node. The required number of machines 1308 indicates the number of virtual machines required for processing the total of traffic loads 1307 and is calculated from the mathematical expression (3) above. In this way, the past data (1302, 1303) and the present data 1304 are recorded at the predetermined periods. While they are recorded every week in the example in FIG. 13, they may be recorded every day or every month. The data to be recorded may be an instantaneous value at a specific time within the period or an average value within the period as far as the recording period occurs at equal intervals.

On the other hand, the future data (1 week later) 1305 indicates the forecasted total of traffic loads 1309 and required number of machines 1310 one week later from the present time. The total of traffic loads 1309 may be forecasted and calculated from totals of traffic loads in the past data (1302, 1303) and the present data 1304 based on a scheme such as a linear approximation, a log approximation, a polynomial approximation, a power approximation, and an exponential approximation. The required number of machines 1310 indicates the number of virtual machines required for processing the total of traffic loads 1309 and may be calculated from the mathematical expression (3) above. Thus, the future data (1305, 1306) records the forecasted and calculated result at predetermined periods.

Referring back to FIG. 12, the management and orchestration server 220 forecasts the number of virtual machines required in future in each virtualized node by using the regular traffic load transition table 1300 in FIG. 13 (step 1202). When the future required number of machines is acquired, the amount of physical resources required in future in the entire system may be calculated from the used resource 704 in the node definition table 700 in FIG. 7. If the amount of physical resources required in future is higher than the amount of physical resources held by the physical server group, the management and orchestration server 220 proposes the time as a scale-out time to an administrator (step 1203).

The routine has been described in which a management and orchestration server forecasts shortage of free resources for a physical server group and proposes to scale out the physical server group to an administrator. By following the routine, necessary and sufficient standby equipment may be reserved from the medium to long point of view. Therefore, even a plurality of types of virtualized nodes maybe employed within a system highly efficiently without hindering the execution of auto-scaling.

### Processing (Flowchart)

A management and orchestration server according to this embodiment performs two operations. More specifically, the management and orchestration server performs an operation for determining and executing scaling of virtual machines included in a virtualized node and an operation for determining and proposing a scale-out time for a physical server group.

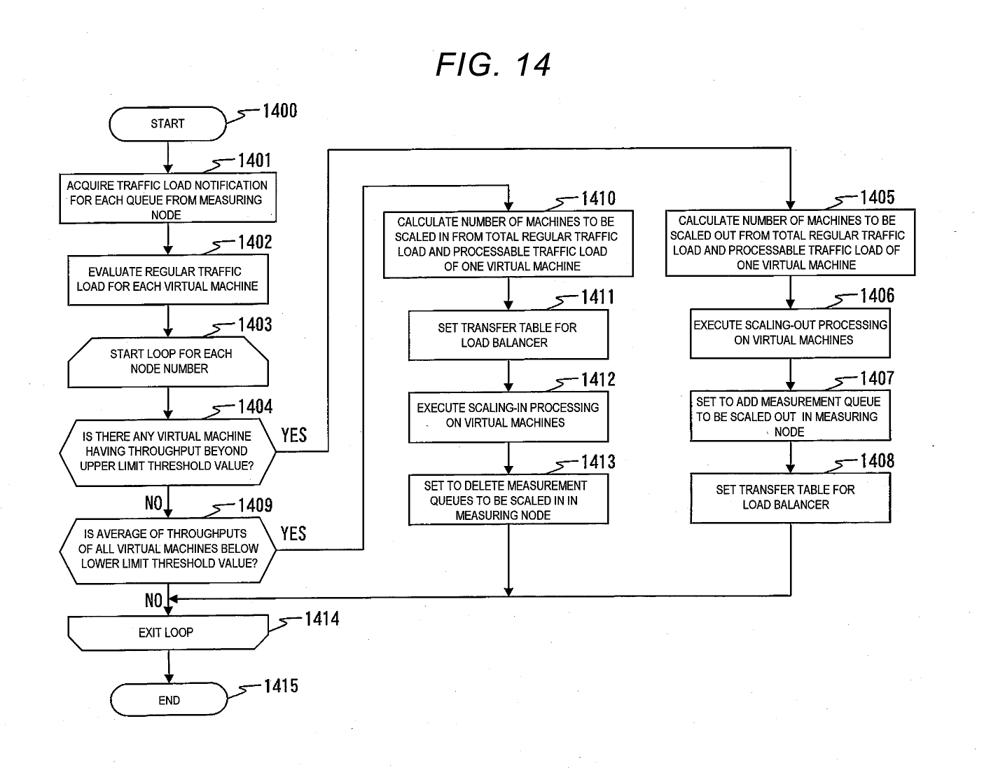

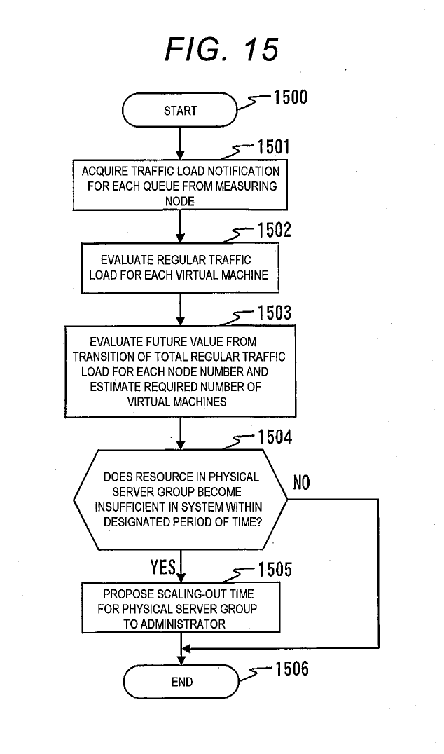

Processing flows of the operations to be performed by the management and orchestration server 220 will be described with reference to FIGS. 14 and 15. The traffic load measuring unit 222 within the management and orchestration server 220 keeps and manages the measurement queue table 900 in FIG. 9 in the following descriptions. The scaling amount determining unit 221 within the management and orchestration server 220 keeps and manages the input traffic type definition table 600 in FIG. 6, the node definition table 700 in FIG. 7, the virtual machine table 800 in FIG. 8, and the regular traffic load transition table 1300 in FIG. 13.

FIG. 14 is a flowchart exemplarily illustrating a flow in which a management and orchestration server determines and executes scaling on virtual machines included in a virtualized node. First, the management and orchestration server 220 starts the processing (step 1400). The traffic load measuring unit 222 within the management and orchestration server 220 acquires a notification of a traffic load for each measurement queue from the measuring node 201 and records the traffic load in the measurement queue table 900 in FIG. 9 (step 1401). Then, the scaling amount determining unit 221 within the management and orchestration server 220 reads the regular traffic load calculation formula 705 in the node definition table 700 in FIG. 7 and the traffic load recorded by the traffic load measuring unit 222 as described above, calculates a regular traffic load of each virtual machine, and records the result in the virtual machine table 800 in FIG. 8 (step 1402). Next, the scaling amount determining unit 221 starts the following loop process for each node number 701 defined in the node definition table 700 (step 1403).

First, the scaling amount determining unit 221 calculates a throughput of each virtual machine from the regular traffic load 804 and the processable traffic load 706 defined in the node definition table 700 among virtual machines matched with the node number 802 in the virtual machine table 800. The scaling amount determining unit 221 then checks whether there is any virtual machine has a throughput beyond the upper limit threshold 707 (step 1404). If so in step 1404, the scaling amount determining unit 221 determines to scale out the virtualized node to which the virtual machine belongs, that is, to execute scale-out of the virtual machines. The scaling amount determining unit 221 reads a total of regular traffic loads and the processable traffic loads 706 in the node definition table 700 of all virtual machines included in the virtualized node and calculates the number N of currently required virtual machines by using the mathematical expression (3) above. The scaling amount determining unit 221 then determines the number of machines to be scaled out from a difference from the current number of virtual machines (step 1405). If the number of machines to be scaled out is determined, the scaling executing unit 223 within the management and orchestration server 220 executes the scale-out processing on virtual machines, as illustrated in step 1002 to step 1004 in FIG. 10 (step 1406). On the other hand, the traffic load measuring unit 222 sets to add a measurement queues relating to the virtual machines scaled out in the measuring node 201 as illustrated in step 1005 to step 1006 in FIG. 10 (step 1407). Finally, the scaling executing unit 223 resets the transfer table for the load balancer 200 (step 1408) and moves to the next loop process, as illustrated in step 1007 in FIG. 10.

Returning to step 1404, if there is no corresponding virtual machine, the scaling amount determining unit 221 calculates a throughput of each virtual machine, like step 1404. The scaling amount determining unit 221 then checks whether the average value of the throughputs of all of the virtual machines included in the virtualized node is lower than the lower limit threshold 708 or not (step 1409). If so in step 1409, the scaling amount determining unit 221 determines to scale in the virtualized node to which the virtual machines belong, that is, executes the scale-in of the virtual machines. The scaling amount determining unit 221 reads a total of regular traffic loads and the processable traffic loads 706 in the node definition table 700 of all virtual machines included in the virtualized node and calculates the number N of currently required virtual machines by using the mathematical expression (3) above. The scaling amount determining unit 221 then determines the number of machines to be scaled in from a difference from the current number of virtual machines (step 1410). If the number of machines to be scaled in is determined, the scaling executing unit 223 resets the transfer table for the load balancer 200, as illustrated in step 1102 in FIG. 11 (step 1411). The scaling executing unit 223 further executes the scale-in processing on the virtual machines, as illustrated in step 1103 to step 1104 in FIG. 11 (step 1412). Finally, the traffic load measuring unit 222 sets to delete the measurement queues relating to the virtual machines scaled in in the measuring node 201, as illustrated in step 1105 to step 1106 in FIG. 11 (step 1413) and moves to the next loop process.

Returning to step 1409, if the average value of the throughputs of all virtual machines included in the virtualized node is not lower than the lower limit threshold 708, the next loop process is performed. If the loop process described above is completely performed on all of the node numbers 701 defined in the node definition table 700 (step 1414), the management and orchestration server 220 ends the series of processing (step 1415). After that, the processing starting from step 1400 periodically restarts.

By following the routine, auto-scaling of a plurality of types of virtualized nodes within a system may be addressed, and the proper number of scaling target machines may be determined from a traffic load measurement result by one operation, which may reduce the convergence time of auto-scaling.

FIG. 15 is a flowchart exemplarily illustrating a flow in which a management and orchestration server determines and proposes a scale-out time for a physical server group. First, the management and orchestration server 220 starts the processing (step 1500). The traffic load measuring unit 222 within the management and orchestration server 220 acquires a notification of a traffic load for each measurement queue from the measuring node 201 and records the traffic load in the measurement queue table 900 in FIG. 9 (step 1501). Then, the scaling amount determining unit 221 within the management and orchestration server 220 reads the regular traffic load calculation formula 705 in the node definition table 700 in FIG. 7 and the traffic load recorded by the traffic load measuring unit 222 as described above, calculates a regular traffic load of each virtual machine, and records the result in the virtual machine table 800 in FIG. 8 (step 1502). The scaling amount determining unit 221 also records the recorded regular traffic load value to the regular traffic load transition table 1300 in FIG. 13.

Next, the scaling amount determining unit 221 evaluates a total of traffic loads of the future data (1305 to 1306) in the regular traffic load transition table 1300 for each of the node numbers 1301 and forecasts the required number of virtual machines in each virtualized node (step 1503). When the future required number of machines is acquired, the scaling amount determining unit 221 may calculate the amount of physical resources required in future in the entire system from the used resource 704 in the node definition table 700 in FIG. 7. The scaling amount determining unit 221 checks whether the amount of physical resources required in future becomes higher than the amount of physical resources held by the physical server group within a designated period of time (such as within 15 weeks) and resource shortage will occur or not (step 1504). If it is determined in step 1504 that the resource shortage will occur, the scaling amount determining unit 221 proposes the time as a scale-out time to an administrator (step 1505). Then, the management and orchestration server 220 ends the processing (step 1506). After that, the process starting from step 1500 periodically restarts.

By following the routine, necessary and sufficient standby equipment may be reserved from the medium to long point of view. Therefore, even a plurality of types of virtualized nodes may be employed within a system highly efficiently without hindering the execution of auto-scaling.

### Second Embodiment

According to a second embodiment, a system configuration of a management and orchestration server in a packet communication system will be described. In this embodiment, the load balancer 200 and the measuring node 201 illustrated in FIG. 2 according to the first embodiment are integrated. Because the configuration example of the communication system to which this embodiment is applied is the same as the configuration in FIG. 1 according to the first embodiment, the description will be omitted.

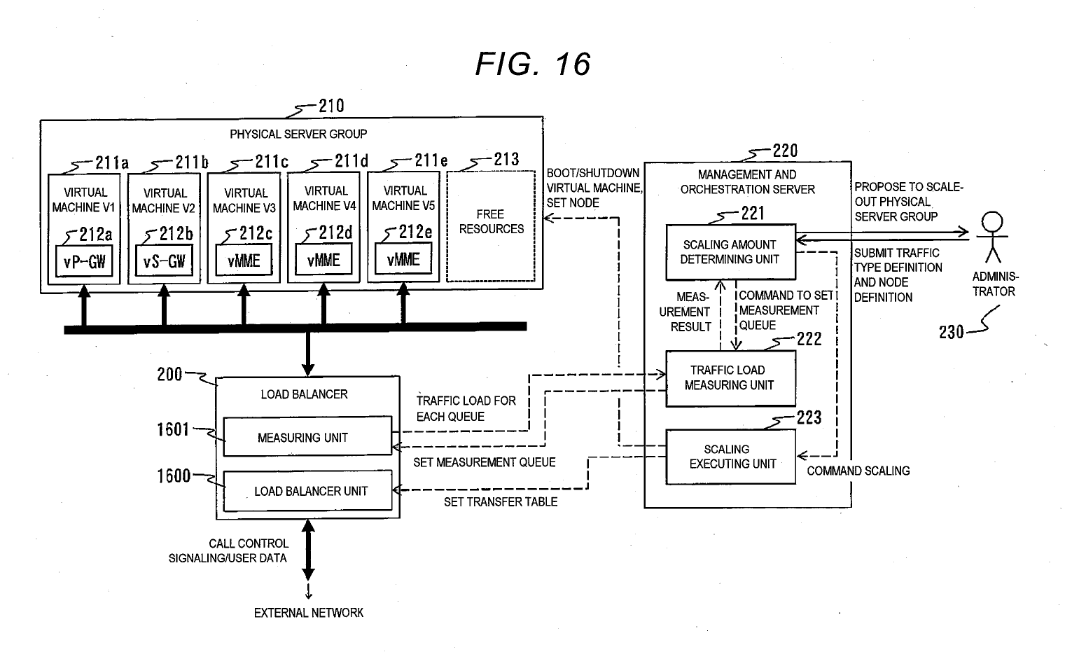

FIG. 16 illustrates an example of a system configuration of this embodiment. This system configuration corresponds to the configuration within the data center 108 illustrated in FIG. 1. This system includes the physical server group 210, load balancer 200, and management and orchestration server 220. The apparatuses are connected via switches or routers. The load balancer 200 includes a load balancer unit 1600 configured to allot a call control signaling or a user data packet received from an external network to a proper virtual machine and a measuring unit 1601 configured to identify the types of traffic input to the virtual machines V1 to V5 (211a to 211e) and measure statistics information on the traffic types. Because the other apparatuses are the same as those in FIG. 2 according to the first embodiment, the description will be omitted. Because the hardware configurations of the management and orchestration server 220/physical server group 210 and the load balancer 200 according to this embodiment are the same as those in Fig. and FIG. 4 according to the first embodiment, the description will be omitted.

Adopting the configurations as described above allows integration of the load balancer 200 and the measuring node 201 and thus reduction of the number of required apparatuses.

Because the processing (including sequences and flows) is the same as those in the first embodiment by replacing the measuring node 201 by the measuring unit 1601 in this embodiment, the description will be omitted.

### Third Embodiment

According to a third embodiment, a system configuration of a packet communication system including a management and orchestration server will be described. In this embodiment, the functions of the measuring node 201 illustrated in FIG. 2 according to the first embodiment are provided in virtual machines. Because the configuration example of the communication system to which this embodiment is applied is the same as the one illustrated in FIG. 1 according to the first embodiment, the description will be omitted.

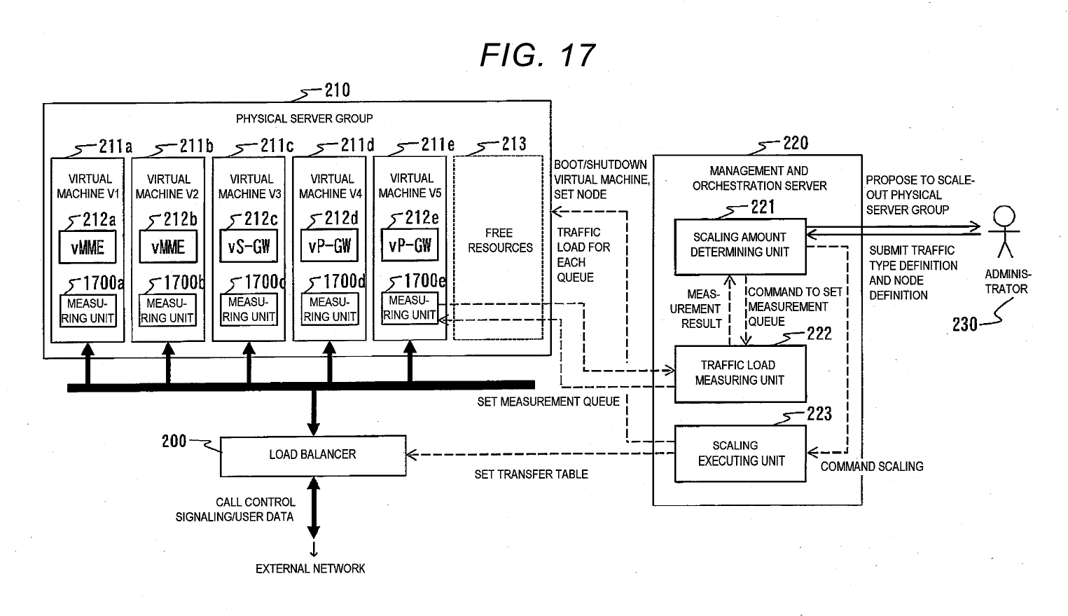

FIG. 17 illustrates an example of a system configuration according to this embodiment. The system configuration corresponds to the configuration within the data center 108 illustrated in FIG. 1. This system includes the physical server group 210, load balancer 200, and management and orchestration server 220. The apparatuses are connected via switches or routers. The physical server group 210 includes virtual machines included in a virtualized node. Referring to FIG. 17, the virtual machines V1 to V5 (211a to 211e) are operating and are executing vP-GW 212a, vS-GW 212b, and vMME (212c to 212e) which are virtualized node software programs. The virtual machines V1 to V5 (211a to 211e) include measuring units (1700a to 1700e), respectively, configured to measure statistics information on traffic types. The measuring units (1700a to 1700e) acquire a traffic load of each traffic type from the virtualized node software programs operating in a same virtual machine and notify them to the management and orchestration server 220. The management and orchestration server 220 includes the scaling amount determining unit 221, traffic load measuring unit 222, and scaling executing unit 223, like the first embodiment. The traffic load measuring unit 222 sets measurement queues for the traffic type to be measured for the measuring units (1700a to 1700e) in each of the virtual machines and acquires a traffic load for each of the queues.

Because other apparatuses and function units are the same as those in FIG. 2 according to the first embodiment, the description will be omitted. Because the hardware configurations of the management and orchestration server 220/physical server group 210 and the load balancer 200 according to this embodiment are the same as those in FIG. 3 and FIG. 4 according to the first embodiment, the description will be omitted.

This configuration including the functions of the measuring node 201 in virtual machines may reduce the required number of apparatuses.

Because the processing (including sequences and flows) is the same as those in the first embodiment by replacing the measuring node 201 according to the first embodiment by a set of measuring units (1700a to 1700e) according to this embodiment, the description will be omitted.

What is claimed is:

1. A management and orchestration server which manages a plurality of types of virtualized nodes included in server group, the management and orchestration server comprising:
a scaling executing unit configured to command the server group to scale virtual machines included in each of the plurality of types of virtualized nodes;
a traffic load measuring unit configured to manage a traffic load of each of the virtual machines; and
a scaling amount determining unit configured to determine a number of the virtual machines to be scaled, wherein
the traffic load measuring unit acquires a traffic load for each of the traffic types to be processed by each of the plurality of types of virtualized nodes; and
the scaling amount determining unit determines the type of virtualized node for which virtual machines are to be scaled and a number of virtual machines to be scaled based on the traffic loads of the traffic types.

2. The management and orchestration server according to claim 1, wherein
each of the plurality of types of virtualized nodes processes a plurality of traffic types; and
the scaling amount determining unit calculates a traffic load normalized by applying weights to traffic loads of the traffic types in accordance with the throughputs of the traffic type and determines a type of virtualized node having the virtual machines to be scaled and the number of machines to be scaled based on the normalized traffic load.

3. The management and orchestration server according to claim 2, wherein the traffic load measuring unit manages a traffic load of each of the virtual machines based on the traffic type; and
the scaling amount determining unit calculates the normalized traffic load for each of the virtual machines and determines to scale out virtual machines included in a predetermined type of virtualized node if the normalized traffic load of at least one virtual machine of virtual machines included in the predetermined type of virtualized node is higher than a first threshold.

4. The management and orchestration server according to claim 3, wherein the scaling amount determining unit determines to scale in virtual machines included in the predetermined type of virtualized node if an average value of the normalized traffic loads of the virtual machines included in the predetermined type of virtualized node is lower than a second threshold.

5. The management and orchestration server according to claim 2, wherein when the type of virtualized node is vS-GW (Virtulized Serving Gateway) or vP-GW (Virtulized Packet Data Network Gateway) in a mobile communication core network, the scaling amount determining unit calculates the normalized traffic loads by applying a larger weight to a call control signaling traffic than a user data traffic among traffic types to be processed by the vS-GW or the vP-GW.

6. The management and orchestration server according to claim 2, wherein when the type of virtualized node is vMME (Virtualized Mobility Management Entity) in a mobile communication core network, the scaling amount determining unit calculates the normalized traffic loads by applying a larger weight to a call control signaling traffic for attach or detach than a call control signaling traffic for handover or connection establishment or connection release among traffic types to be processed by the vMME.

7. The management and orchestration server according to claim 2, wherein the scaling amount determining unit includes an interface usable by an administrator for submitting a definition setting for the plurality of traffic types and a definition setting for the plurality of types of virtualized node.

8. The management and orchestration server according to claim 2, wherein
if the scaling amount determining unit determines to scale out virtual machines, the scaling amount determining unit instructs the traffic load measuring unit to start acquisition of the plurality of traffic types for the virtual machines to be scaled out; and
the traffic load measuring unit sets other apparatuses that measure traffic loads of the corresponding virtual machines to notify the plurality of traffic types to the virtual machines to be scaled out.

9. The management and orchestration server according to claim 8,
if the scaling amount determining unit determines to scale in virtual machines, the scaling amount determining unit instructs the traffic load measuring unit to finish acquisition of the plurality of traffic types for the virtual machines to be scaled in; and
the traffic load measuring unit sets the other apparatuses not to notify the plurality of traffic types to the virtual machines to be scaled in.

10. The management and orchestration server according to claim 2, wherein the scaling amount determining unit forecasts a future traffic load based on a transition of past traffic loads for each of the virtualized nodes and includes an interface usable for notifying an administrator of scale-out of physical resources in the server group for scaling out virtual machines if it is determined that shortage of the physical resources will occur within a predetermined period.
